(19) United States
(12) Patent Application Publication
(10) Pub. No.: US 2014/0127099 A1
(43) Pub. Date: May 8, 2014

(54) Device for Purifying Exhaust Gases from a Heat Engine, Comprising a Catalytic Ceramic Support Comprising an Arrangement of Essentially Identical Crystallites

(71) Applicants: L'Air Liquide Societe Anonyme Pour L'Etude Et L'Exploitation Des Procedes Georges Claude, Paris (FR); Centre National De La Recherche Scientifique, Paris (FR); Universite De Limoges, Limoges Cedex (FR)

(72) Inventors: Pascal Del-Gallo, Dourdan (FR); Fabrice Rossingnol, Verneuil Ser Vienne (FR); Thierry Chartier, Feytiat (FR); Raphael Faure, Villebon-Sue-Yvette (FR); Sebastien Goudalle, Sens (FR); Claire Bonhomme, Panazol (FR)

(73) Assignees: L'Air Liquide Societe Anonyme Pour L'Etude Et L'Exploitation Des Procedes Georges Claude, Paris (FR); Centre National De La Recherche Scientifique, Paris (FR); Universite De Limoges, Limoges Cedex (FR)

(21) Appl. No.: 14/128,458

(22) PCT Filed: Jun. 8, 2012
(86) PCT No.: PCT/EP2012/060901

§ 371 Date: Dec. 20, 2013

(30) Foreign Application Priority Data
Jun. 27, 2011 (FR) 1155683

(51) Int. Cl. F01N 3/28; B01D 53/94

(52) U.S. Cl. CPC F01N 3/2832; B01D 53/9454
USPC 423/212; 422/177

(57) ABSTRACT

Device for purifying exhaust gases from a thermal combustion engine, comprising a catalytic ceramic carrier comprising an arrangement of crystallites of the same size, same isodiametric morphology and same chemical composition or substantially the same size, same isodiametric morphology and same chemical composition, wherein each crystallite is in contact at a singular or almost singular point with surrounding crystallites, and whereon at least one active phase is deposited for the chemical destruction of impurities in the exhaust gas.

The invention concerns a device for purifying the exhaust gases of a thermal combustion engine, in particular for a motor vehicle, comprising a carrier on which at least one catalyst is deposited for the chemical destruction of impurities in the exhaust gases, commonly referred to as a “catalytic converter”. The function of such a device is to at least partly eliminate the polluting gases contained in the exhaust gases, in particular carbon monoxide, hydrocarbons and nitrogen oxides, by converting them by means of reduction or oxidation reactions.

The invention in particular proposes exhaust gas purification devices comprising oxide ceramic carriers suitable for heterogeneous catalysis, the structural characteristics of which afford performances superior to those of conventional catalyst oxide carriers.

Synergies between various chemical and petrochemical industrial applications and the operating conditions of a motor vehicle engine have been observed. It is noted that the process closest to that of an engine operating at full load is the SMR (Steam Methane Reforming) process in terms of temperature and gaseous compositions (CH₄, H₂O, CO₂, CO, etc). This is in particular true for catalytic materials on the aspects relating to choice of the active phases (noble metals, Ni, etc), degradation of the oxide carriers and/or the active phases, temperature zones (600°-1000° C.) and to a certain extent the spatial speed in particular in the context of SMR structured reactors-exchangers. The consequence is in particular physical degradation phenomena (temperature causing coalescences of nanoparticles, delamination of deposits, etc) that are very similar.

A gas-solid heterogeneous catalyst is generally an inorganic material consisting of at least one ceramic carrier, oxide or not, on which one or more active phases are dispersed that convert reagents into products through repeated and uninterrupted cycles of elementary phases (adsorption, dissociation, diffusion, reaction-recombination, diffusion, desorption). The carrier may in certain cases act not only physically (high porous volume and BET surface for improving the dispersion of the active phases) but also chemically (accelerating for example the dissociation and diffusion of specific molecules). The catalyst participates in the conversion by returning to the original state thereof at the end of each cycle during the whole of the service life thereof. A catalyst modifies/accelerates the reaction mechanism or mechanisms and the associated reaction kinetics without changing the thermodynamics thereof.

In order to maximise the degree of conversion of supported catalysts, it is essential to maximise the accessibility of the reagents through the active particles. For the purpose of comprehending the advantage of a carrier such as that developed herein, the main steps of a heterogeneous catalysis reaction are stated first of all. A gas composed of molecules A passes through a catalytic bed, and reacts on the surface of the catalyst in order to form a gas of species B.

All the elementary steps are:

a) transport of the reagent A (diffusion in volume), through a layer of gas, as far as the external surface of the catalyst,
b) diffusion of the species A (diffusion in volume or molecular (Knüdsen)), through the porous lattice of the catalyst, as far as the catalytic surface,
c) adsorption of the species A on the catalytic surface,
d) reaction of A in order to form B on the catalytic sites present on the surface of the catalyst,
e) desorption of the product B from the surface,
f) diffusion of the species B through the porous lattice,
g) transport of the product B (diffusion in volume) from the external surface of the catalyst, through the layer of gas, as far the gas stream.

The number of reactive molecules converted into product or products in a defined interval of time is directly related to the accessibility and the numbers of catalytic site or sites available. It is therefore necessary to initially increase to the maximum possible extent the number of active sites available per unit surface. To do this, it is necessary to reduce the size of the metal nanoparticles (from 1.5 to 3 nm) and maximise the dispersion of said active nanoparticles on the surface of the carrier. So as to reduce the mean size of the particles and active phases and to maximise the dispersion thereof, it is necessary to provide a carrier itself having a maximum specific surface area and a suitable porous volume.

The active species in the context of the automobile depollution reaction and steam reforming reaction may be one of the noble metals (ruthenium, rhenium, rhodium, palladium, osmium, iridium or platinum), or an alloy between one, two or three of these noble metals or a transition metal and one, two or three noble metals. Nickel, silver, gold, copper, zinc and cobalt can be cited as transition metals. The ideal is to disperse nanometric active phases (<5 nm) on the surface of a ceramic carrier in general. The smaller the catalytic particle, the larger its surface to volume ratio will be and thus the larger the developed surface area per unit mass would be (for the active phases, reference is made to MSA: Metallic Surface Area, expressed as surface area per unit mass, such as m²/g of metal for example; for catalytic ceramic carriers, reference is made to BET surface area and/or porous volume). Another consequence is obviously the reduction in costs, in particular the one related to the impact of the price of the raw materials (noble metals). Control of the process for producing the carrier or carriers and the chemical stability thereof must not only maximise the dispersion and size of the active phase or phases (noble metal or metals optionally associated with transition metals) but also reduce the quantity of active phase or phases used, and therefore the associated cost, related directly to the price of the raw materials and the availability thereof.

By definition, a ceramic surface receiving energy (for example calorific) will always tend to minimise the energy thereof. The two main barriers to the development of ceramic carriers with high specific surface areas and porous volumes are:

sintering, a natural phenomenon appearing at temperature; and

the change in crystalline phase: a change in phase is usually accompanied by destructuring.

These two phenomena are linked to each other and result in a reduction in the specific surface area of the material in question, a collapse in the associated porous volume and a redistribution of pore sizes with the appearance of macroporosity to the detriment of micro- and mesoporosity. The example will be taken of the conversion of γ alumina into α alumina occurring spontaneously above 1100° C. in air (as from 800°-900° C. under SMR conditions). The specific surface area of a γ alumina may range up to several hundreds of m²/g whereas a standard a alumina has a specific surface area of less than around 10 m²/g. γ alumina is conventionally used in particular in automobile depollution as a catalytic carrier optionally stabilised with lanthanum, cerium, zirconium, etc. In all cases, however, after a few stop-start automobile cycles, the specific surface area of optionally stabilised gamma alumina collapses, causing/promoting the migration of active particles resulting in a coalescence thereof. To prevent excessively rapid deactivation of the catalytic performance, the manufacturers of catalysts deposit larger quantities of noble metals so as to minimise the impact related to the degradation of the structural properties of the ceramic carrier.

Several ceramic carriers with a high specific surface area and porous volume have already been synthesised.

Silica is the first mesoporous material to have been synthesised in 1992. The document US2003/0039744A1 discloses, using the method of auto-assembly caused by evaporation, how to obtain a mesoporous silica carrier.

The documents Crepaldi, E. L., et al., Nanocrystallised titania and zirconia mesoporous thin films exhibiting enhanced thermal stability, New Journal of Chemistry, 2003. 27(1): p. 9-13 and Wong, M. S. and J. Y. Ying, Amphiphilic Templating of Mesostructured

Zirconium Oxide, Chemistry of Materials, 1998. 10(8) : p. 2067-2077, describe the synthesis of mesoporous zirconia. As with the majority of mesoporous materials, thermal stability is ensured only up to 500° C.-600° C. For higher temperatures, there is a collapse of structure by sintering or phase change.

A review by Kaspar, J. et al., Nanostructured materials for advanced automotive de-pollution catalysts, Journal of Solid State Chemistry 171(2003): p 19-29, presents the prior art in the search for nanostructured materials for optimising three-way catalyst (TWC) oxide carriers in the automobile industry. The synthesis methods identified as the most promising are co-precipitation and sol gel. Current three-way catalyst carriers are composed of a mixture of gamma alumina generally (γ-Al₂O₃), ceria (CeO₂) and zirconia (ZrO₂). The article concludes that it is necessary to develop new synthesis methods for stabilising nanomaterials under the operating conditions of catalytic converters. The main problem is the non-stability under operating conditions of the synthesis carrier materials in relation to the thermal cycles (300°-1000° C.) and atmosphere containing a mixture of exhaust gases (CO, H₂O, NO, N₂, CₓH_{y}, O₂, N₂O etc). There is a collapse of the specific surface area of the oxide carrier, changing from 50-200 m²/g to less than 10 m²/g after a few thermal cycles (cf. table 1: effect of the calcination temperature on the BET surface area of oxides).

TABLE N° 1

| | | Calcination conditions and BET surface area | | | | |
|---|---|---|---|---|---|---|
| Composition | Synthesis method | Temp./time | BET area | Temp./time | BET Area | Refs./notes |
| CeO₂ | Co-precpt. | 823 K/2 h | 55 | 973 K/2 h | 5 | [79] |
| Ce_{0.8}Zr_{0.2}O₂ | Co-precpt. | 823 K/2 h | 85 | 973 K/2 h | 30 | [79] |
| Ce_{0.83}Zr_{0.17}O₂ | Co-precpt. | 773 K/6 h | 85 | 973 K/6 h | 58 | [80]/3 m²g⁻¹ |
| | | | | | | (1273 K, 6 h) |
| Ce_{0.67}Zr_{0.33}O₂ | Co-precpt. | 773 K/6 h | 104 | 973 K/6 h | 70 | [80]/8 m²g⁻¹ |
| | | | | | | (1273 K, 6 h) |
| Ce_{0.90}Zr_{0.10}O₂ | Co-precpt. | 1053 K/4 h | 25 | 1173 K/4 h | 18 | [62] |
| Ce_{0.75}Zr_{0.25}O₂ | Sol-gel | 1053 K/4 h | 56 | 1173 K/4 h | 35 | [62] |
| | Co-precpt. | 773 K/1 h | 72 | 1273 K/4 h | 14 | [24] |
| Ce_{0.85}Zr_{0.17}O₂ | Co-precpt. | 773 K/1 h | 87 | 1273 K/4 h | 14 | [24] |
| Ce_{0.5}Zr_{0.5}O₂ | Co-precpt. at 573 K | 573 K | 105 | 1273 K/1 h | 15 | [92] |
| Ce_{0.2}Zr_{0.8}O₂ | Co-precpt. at 373 K | | | 1273 K/ | 50 | [46] |
| Ce_{0.6}Zr_{0.4}O₂ | Co-precpt. at 373 K | | | 1273 K/ | 43 | [46] |
| Ce_{0.8}Zr_{0.7}O₂ | Co-precpt. at 373 K | | | 1273 K/ | 33 | [46] |
| Ce_{0.8}Zr_{0.2}O₂ | Co-precpt./organic | 723 K/2 h | 209 | 1173 K/2 h | 56 | [47] |
| | template | | | | | |
| Ce_{0.3}Zr_{0.5}O₂ | Cellulose template | 1073 K/2 h | 129 | 1323 K/12 h | 30 | [104] |

Thereon this basis, one problem that is posed is that of providing a device for purification of the exhaust gases of a thermal combustion engine comprising a catalytic ceramic carrier having good physicochemical stability under severe operating conditions (i.e. magnitude of the temperature changes and atmosphere modification).

One solution of the invention is a device for purification of the exhaust gases of a thermal combustion engine, comprising a catalytic ceramic carrier comprising an arrangement of crystallites of the same size, the same isodiametric morphology and the same chemical composition or substantially the same size, the same isodiametric morphology and the same chemical composition in which said crystallite is in contact at a singular or almost singular point with surrounding crystallites, and on which at least one active phase is deposited for the chemical destruction of impurities in the exhaust gas.

It should be noted that the first advantage of the catalytic ceramic carrier used in the purification device according to the invention is that of developing a large available specific surface area, typically greater than or equal to 20 m²/g and up to several hundreds of m²/g. Moreover, it is stable in terms of specific surface area at least up to 1000° C. in an atmosphere containing a mixture of exhaust gases (CO, H₂O, NO, N₂, CₓH_{y}, O₂, N₂O etc).

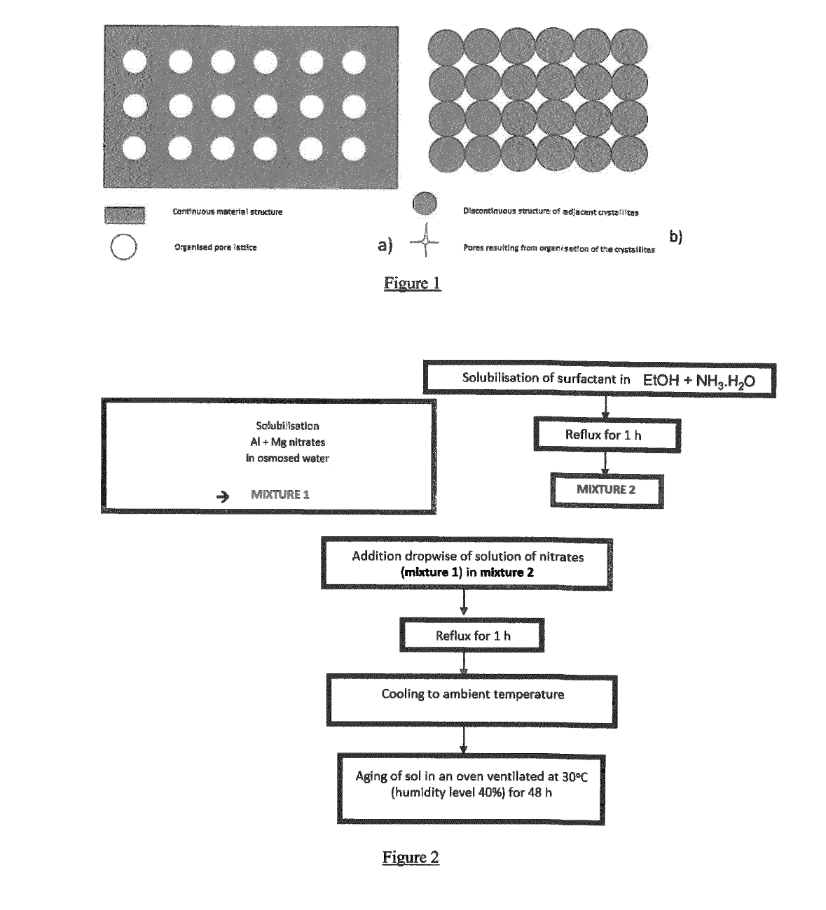

FIG. 1a) shows schematically a catalytic carrier according to the prior art. It is more precisely a mesoporous structure.

FIG. 1b) shows schematically a catalytic carrier used in the purification device according to the invention. According to this figure, each crystallite is in contact with six other crystallites in a plane (i.e. compact stacking)

According to the circumstances, the catalytic ceramic carrier used in the purification device according to the invention may have one or more of the following features:

the arrangement of crystallites is a compact hexagonal or centred face cubic stack in which each crystallite is in contact at a singular or almost singular point with no more than twelve other crystallites in a 3-dimensional space;

said arrangement is made of alumina (Al₂O₃), or ceria (CeO₂) optionally stabilised with gadolinium oxide, or zirconia (ZrO₂) optionally stabilised with yttrium oxide or spinel phase or lanthanum oxide (La₂O₃) or a mixture of one or more of these compounds;

the crystallites are substantially spherical in shape;

the crystallites have a mean equivalent diameter of between 2 and 20 nm, preferably between 5 and 15 nm;

said carrier comprises a substrate and a film on the surface of said substrate comprising said arrangement of crystallites;

said ceramic carrier comprises granules comprising said arrangement of crystallites;

the granules are substantially spherical in form.

The catalytic ceramic carrier used in the purification device according to the invention may be deposited (wash coated) on a ceramic and/or metallic carrier optionally coated with ceramic with various architectures such as alveolar structures, barrels, monoliths, honeycomb structures, spheres, multi-scale structured reactors-exchangers (microreactors), etc.

The present invention also relates to a method for purifying exhaust gases from a thermal engine in which said exhaust gases are circulated through a device according to the invention.

The thermal engine is preferably a motor vehicle engine, in particular a petrol or diesel engine.

We shall now see in detail how the catalytic ceramic carriers used in the purification device according to the invention are synthesised.

According to a first synthesis method, the following steps are performed for synthesising the catalytic ceramic carrier:

a) preparation of a sol comprising nitrate and/or carbonate salts of aluminium and/or magnesium and/or cerium and/or zirconium and/or yttrium and/or gadolinium and/or lanthanum, a surfactant and solvents such as water, ethanol and ammonia;

b) dipping of a substrate in the sol prepared in step a);

c) drying of the substrate impregnated with sol so as to obtain a gelled composite material comprising a substrate and a gelled matrix; and

d) calcination of the composite material gelled in step c) at a temperature of between 500° C. and 1000° C., preferably between 700° C. and 900° C., even more preferentially at a temperature of 900° C.

Preferably, the substrate used in this first synthesis method is made from dense alumina or cordierite or mullite or silicon carbide.

According to a second synthesis method, the following steps are performed for synthesising the catalytic ceramic carrier:

a) preparation of a sol comprising nitrate and/or carbonate salts of aluminium and/or magnesium and/or cerium and/or zirconium and/or yttrium and/or gadolinium and/or lanthanum, a surfactant and solvents such as water, ethanol and ammonia;

b) atomisation of the sol in contact with a stream of hot air so as to evaporate the solvent and form a micronic powder;

c) calcination of the powder at a temperature of between 500° C. and 1000° C., preferably between 700° C. and 900° C., even more preferentially at a temperature of 900° C.

The two methods for synthesising catalytic ceramic carriers mentioned above may have one or more of the following features:

the sol prepared in step a) is aged in an oven ventilated at a temperature of between 15° and 35° C. for a period of 24 hours.

the calcination step d) is performed in air and for a period of 4 hours.

The sol prepared in the two methods for synthesising ceramic carriers mentioned above preferably comprises four main constituents:

Inorganic precursors: for reasons of cost limitation, it was chosen to use nitrates of magnesium, aluminium, cerium, zirconium, yttrium, gadolinium or lanthanum. The stoichiometry of these nitrates can be checked by ICP (Induced Coupled Plasma), before the solubilisation thereof in osmosed water. Any other chemical precursor (carbonate, chloride, etc) can be used in the production method.

The surfactant, otherwise referred to as a surface-active agent. It is possible to use a Pluronic F127 triblock copolymer of the EO-PO-EO type. It has two hydrophilic blocks (EO) and a hydrophobic central block (PO).

The solvent (absolute ethanol).

NH₃.H₂O (28% by mass). The surfactant is solubilised in an ammoniacal solution that creates hydrogen bonds between the hydrophilic blocks and the inorganic species.

An example of molar ratios between these various constituents is given in the following table (Table 1):

| | |
|---|---|
| n_{H2O}/nₙᵢₜᵣₐₜₑ | 111 |
| n_{EtOH}/nₙᵢₜᵣₐₜₑ | 38 |
| n_{F127}/nₙᵢₜᵣₐₜₑ | 6.7 × 10⁻³ |
| n_{F127}/n_{H2O} | 6.0 × 10⁻⁶ |

The method for preparing the sol is described in FIG. 2.

In the following paragraph, the quantities between parentheses correspond to only one example.

The first step consists of solubilising the surfactant (0.9 g) in absolute ethanol (23 ml) and in an ammoniacal solution (4.5 ml). The mixture is next heated at reflux for 1 hour. Then the previously prepared solution of nitrates (20 ml) is added drop by drop to the mixture. The whole is heated at reflux for 1 hour and then cooled to ambient temperature. The sol thus synthesised is aged in a ventilated oven, wherein the ambient temperature (20° C.) is precisely controlled.

In the case of the first synthesis method, the dipping consists of plunging a substrate in the sol and removing it at constant speed. The substrates used in the context of our study are alumina plates sintered at 1700° C. for 1 hour 30 minutes in air (relative density of the substrates =97% with respect to theoretical density).

When the substrate is removed, the movement of the substrate entrains the liquid, forming a surface layer. This layer is divided into two; the internal part moves with the substrate whereas the external part falls back into the receptacle. The gradual evaporation of the solvent leads to the formation of a film on the surface of the substrate.

It is possible to estimate the thickness of the deposit obtained according to the viscosity of the sol and the withdrawal rate (Equation 1):

e∞κv^{2/3} Equation 1

with κ a deposition constant dependent on the viscosity and density of the sol and the liquid-vapour surface tension. v is the withdrawal rate.

Thus the higher the withdrawal rate, the greater the thickness of the deposit.

The dipped substrates are then oven-dried at between 30° C. and 70° C. for a few hours. A gel is then formed. A calcination of the substrates in air eliminates the nitrates but also decomposes the surfactant and thus releases the porosity.

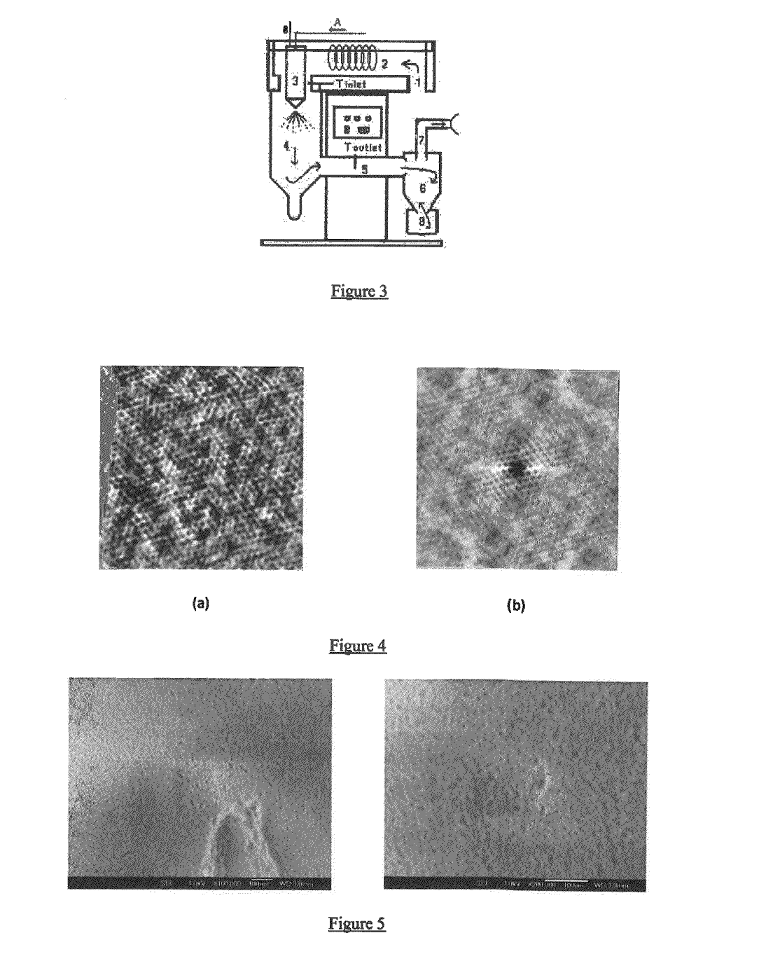

In the case of the second synthesis method, the atomisation technique transforms a sol into solid dry form (powder) by the use of a hot intermediate (FIG. 3).

The principle is based on atomisation of the sol 3 in fine droplets, in an enclosure 4 in contact with a hot air stream 2 in order to evaporate the solvent. The powder obtained is entrained by the flow of heat 5 as far as a cyclone 6 that will separate the air 7 from the powder 8.

The apparatus that can be used in the context of the present invention is a commercial model referenced “190 Mini Spray Dryer” of Büchi make.

The powder recovered at the end of the atomisation is dried in an oven at 70° C. and then calcined.

Thus, in both methods, the precursors, that is to say in this example magnesium and aluminium nitrate salts, are partially hydrolysed (Equation 2).

Then the evaporation of the solvents (ethanol and water) crosslinks the sol into gel around surfactant micelles through the formation of bonds between the hydroxyl grouping of a salt and the metal of another salt (Equations 3 and 4).

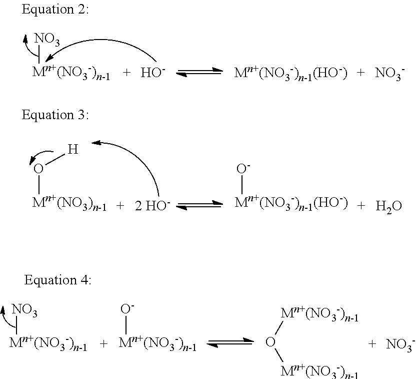

Control of these reactions related to the electrostatic interactions between the inorganic precursors and the surfactant molecules enables a cooperative assembly of the organic and inorganic phases, which generates micellar aggregates or surfactants of controlled size in an inorganic matrix.

This is because the non-ionic surfactants used are copolymers that have two parts with different polarities: a hydrophobic body and hydrophilic ends. These copolymers form part of the family of block copolymers consisting of polyalkylene oxide chains. One example is the polymer (EO)n-(PO)m-(EO)n, formed by the concatenation of hydrophilic polyethylene oxide (EO) at the ends and, in the central part thereof, hydrophobic polypropylene oxide (PO). The polymer chains remain dispersed in solution at a concentration less than the critical micellar concentration (CMC). The CMC is defined as being the limit concentration beyond which the phenomenon of self-arrangement of the surfactant molecules in the solution occurs. Beyond this concentration, the surfactant chains have a tendency to group together by hydrophilic/hydrophobic affinity. Thus the hydrophobic bodies group together and form micelles with a spherical shape. The ends of the chains of polymers are pushed out of the micelles and combine during the evaporation of the volatile solvent (ethanol) with the ionic species in solution, which also have hydrophilic affinities.

This self-arrangement phenomenon occurs during drying steps c) of the methods for synthesising the ceramic carriers mentioned above.

Let us now see the advantages of calcination at a temperature of between 500° C. and 1000° C.

First, the substrate coated with a thin film was calcined in air at 500° C. for 4 hours, with a temperature rise rate of 1° C./min.

The sample is observed by means of a high-resolution scanning electron microscope (SEM-FEG) and an atomic force microscope (AFM). The atomic force microscope takes account of the surface topography of a sample with a resolution that is ideally atomic. The principle consists of scanning the surface of the sample with a tip, the end whereof is of atomic size, while measuring the interaction forces between the end of the spike and the surface. With a constant interaction force, it is possible to measure the topography of the sample.

The AFM images produced on a surface area of 500 nm² (FIG. 4) and the SEM-FEG micrographs (FIG. 5) reveal the formation of a mesostructured deposit at this calcination temperature. FIG. 4a) is a topography image while FIG. 4b) is an auto-correlation image.

The mesostructuring of the material follows a progressive concentration, in the deposit, of precursors of aluminium and magnesium, as well as of the surfactant, up to a micellar concentration greater than the critical concentration, which results in the evaporation of the solvents.

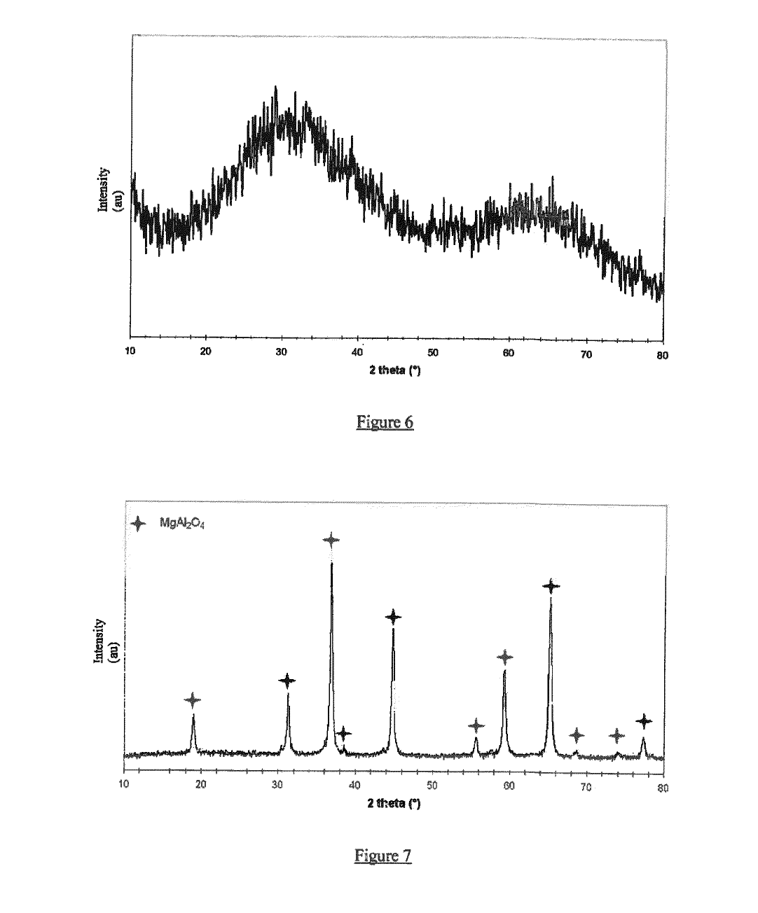

On the other hand, at this calcination temperature (500° C.-4 hours), the spinel phase is not completely formed and the compound is amorphous (FIG. 6). The diffractogram was produced on powder obtained by atomisation of the sol.

For this reason, we have chosen to increase the calcination temperature of the material to 900° C.

At this temperature, the spinel phase (MgAl₂O₄) is perfectly crystallised (FIG. 7). Calcination at 900° C. destroys the mesostructuring of the deposit that was present at 500° C. The crystallisation of the spinel phase causes a local disorganisation of the porosity. The result is nevertheless a catalytic ceramic carrier used in the purification device according to the invention, in other words an ultra divided and very porous deposit with almost spherical particles in contact with each other at a singular or almost singular point (FIG. 8). FIG. 8 corresponds to three SEM-FEG micrographs of the catalytic carrier with three different magnifications.

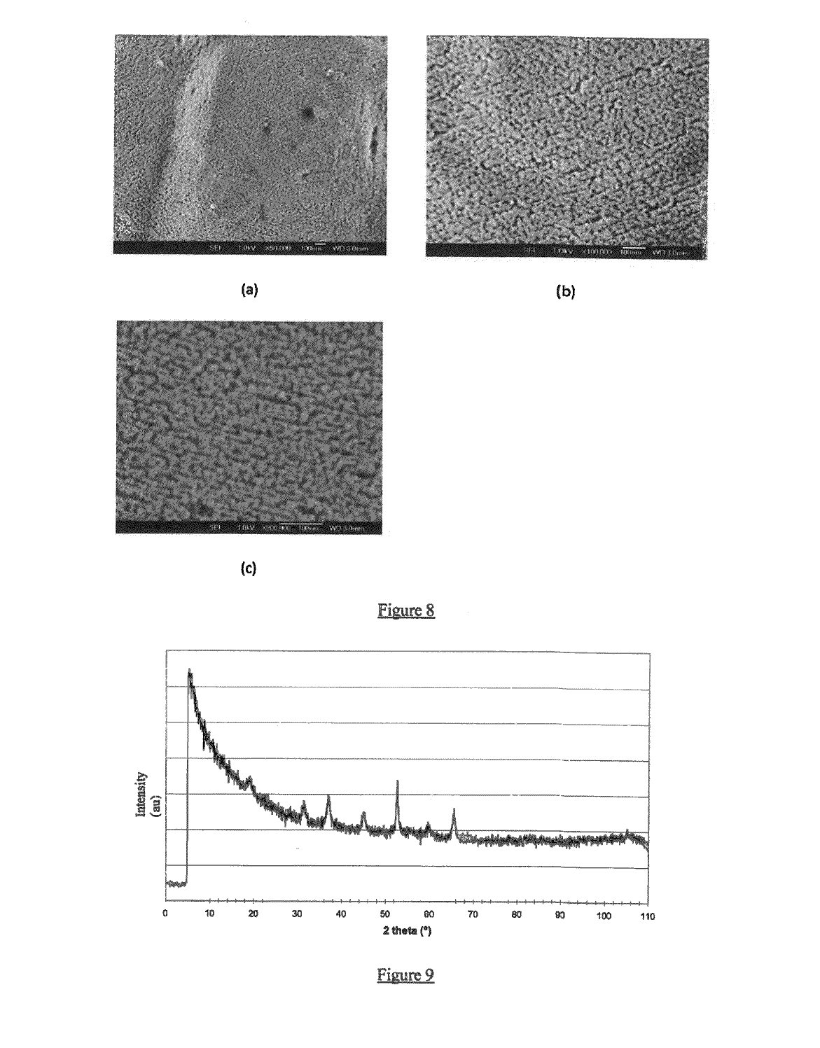

These particles display a very tight granulometric distribution centred on 12 nm (mean size of the spinel crystallites measured by small-angle X-ray diffraction, FIG. 9). This size corresponds to that of the elementary particles observed in scanning electron microscopy indicating that the elementary particles are mono crystalline.

Small-angle X-ray diffraction (values of the angle 2θ between 0.5° and)6°): this technique enabled us to determine the size of the crystallites of the catalyst carrier. The diffractometer used in this study, based on a Debye-Scherrer geometry, is equipped with a curved position detector (Inel CPS 120) at the centre of which the sample is positioned. The latter is a monocrystalline sapphire substrate on which the sol has been deposited by dipping-withdrawal. The Scherrer formula makes it possible to correlate the mid-height width of the diffraction peaks with the size of the crystallites (Equation 5).

$$D = 0 , 9 \times \frac{λ}{β cos θ} \qquad Equation 5$$

D corresponds to the size of the crystallites (nm)
λ is the wavelength of the Ka line of Cu (1.5406 Å)
β corresponds to the mid-height width of the line (in rad)
θ corresponds to the diffraction angle.

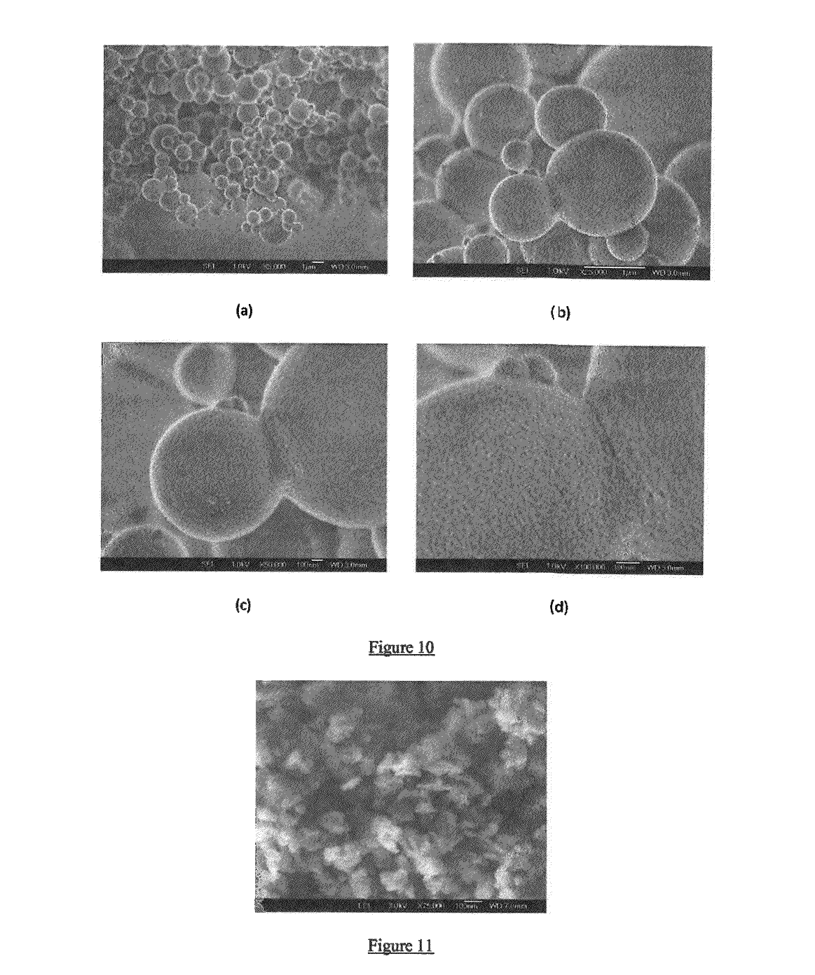

Atomisation of the sol, followed by a calcination of the powder at 900° C., produces spherical granules with a diameter of less than 5 μm and preferably in a range between 100 nm and 2 μm (FIG. 10). The microstructure of this powder is identical to that obtained on the deposit, namely an ultra-divided porous microstructure with a crystallite size of the same order of magnitude.

The specific surface area of the powder, measured by the BET method, is 50 m2/g.

The morphology of the powder was compared with that of a spinel-phase powder with the commercial name Puralox MG30, supplied by the company Sasol (FIG. 11). This powder has a specific surface area of 30 m²/g.

The commercial powder particles are not spherical and the granulometric distribution thereof is wide, which potentially will favour an enlargement of the particles (physical deactivation) during aging under automobile conditions (temperature between 300° and 1000° C., stop-start cycles, specific atmosphere).

The catalytic ceramic carriers obtained by dipping the sol on a substrate, in other words comprising a substrate and a film, as well the catalytic ceramic carriers obtained by atomisation of the sol, in other words comprising granules, were aged under the operating conditions of catalytic convertors, namely a temperature of 900° C. for 100 hours in an atmosphere containing a mixture of exhaust gases (CO, H₂O, NO, N₂, CₓH_{y}, O₂, N₂O, etc).

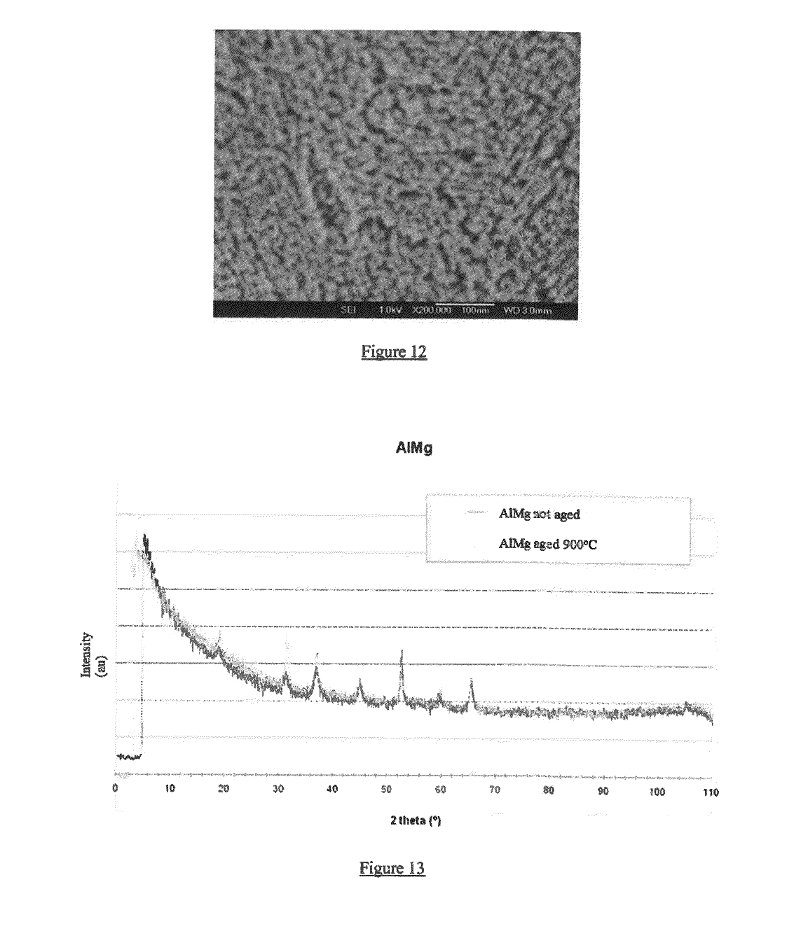

The ultra-divided microstructure of the deposits calcined at 900° C. changes little during aging (FIG. 12). The very great homogeneity of size, morphology and chemical composition as well as the ultra-division (i.e. a limited number of contacts between particles) considerably limit the local gradients in chemical potential that constitute the driving force of the migration of the species responsible for sintering. Conservation of the size of the particles was confirmed by the small-angle X-ray diffraction results (FIG. 13). This is because the size of the elementary monocrystalline particles measured by this technique is 14 nm after aging (grey curve). It was 12 nm before aging (black curve). No collapse of the structure was observed.

The specific surface area of the aged powder is 41 m²/g thus showing a very small reduction of the specific surface area.

The example described (spinel carrier) with the associated production methods can be extended to other ceramic carrier families such that said carrier is made of alumina (Al₂O₃), or ceria (CeO₂) optionally stabilised with gadolinium oxide, or zirconia (ZrO₂) optionally stabilised with yttrium oxide (such as YSZ 4 and 7-10%) or lanthanum oxide (La₂O₃) or spinel phase (for example MgAl₂O₄) or a mixture of one or two or three or four of these compounds. Compounds based on alumina stabilised by ceria and/or zirconium and/or lanthanum to the extent of 2-20% by mass can also be mentioned. The microstructures obtained are identical to those described in the example detailed above.

1-11. (canceled)

12. A device for purifying exhaust gases from a thermal combustion engine, comprising a catalytic ceramic carrier having a specific surface area greater than or equal to 20 m²/g and comprising an arrangement of crystallites of the same size, same isodiametric morphology and same chemical composition or substantially the same size, same isodiametric morphology and same chemical composition, the crystallites having a mean equivalent diameter of between 2 and 20 nm, wherein each crystallite is in contact at a singular or almost singular point with surrounding crystallites, and whereon at least one active phase is deposited for the chemical destruction of impurities in the exhaust gas.

13. The device of claim 12, wherein the arrangement of crystallites is optimally a compact hexagonal or centred-face cubic stack wherein each crystallite is in contact at a singular or almost singular point with no more than 12 other crystallites in a 3-dimensional space.

14. The device of claim 12, wherein said arrangement is made from alumina (Al₂O₃), or ceria (CeO₂) optionally stabilised with gadolinium oxide, or zirconia (ZrO₂) optionally stabilised with yttrium oxide or spinel phase or lanthanum oxide (La₂O₃) or magnesium oxide or silica or a mixture of one or more of these compounds.

15. The device of claim 12, wherein the crystallites are substantially spherical in shape.

16. The device of claim 15, wherein the crystallites have a mean equivalent diameter of between 5 and 15 nm.

17. The device of claim 12, wherein said carrier comprises a substrate and a film on the surface of said substrate comprising said arrangement of crystallites.

18. The device of claim 12, wherein said ceramic carrier comprises granules comprising said arrangement of crystallites.

19. The device of claim 18, wherein the granules are substantially spherical in shape.

20. A method for purifying exhaust gases from a thermal combustion engine, wherein exhaust gases are circulated through the device of claim 12.

21. The method of claim 20, wherein the thermal combustion engine is a motor vehicle engine.

22. The method of claim 20, wherein the thermal combustion engine is a diesel engine.

23. The purification method of claim 20, wherein the thermal combustion engine is a petrol engine.
